(19) United States
(12) Patent Application Publication
(10) Pub. No.: US 2003/0229506 A1
(43) Pub. Date: Dec. 11, 2003

(54) System and method that provides access control and monitoring of consumers using mass transit systems

(75) Inventors: Walter G. Scott, North Palm Beach, FL (US); William G. Siegel, Wellington, FL (US); Gregory L. Cannon, Boynton Beach, FL (US); Thomas Buss, Jupiter, FL (US); George W. McClurg, Jensen Beach, FL (US); Mark Southwick, Lake Worth, FL (US); Richard Irving, Palm Beach Gardens, FL (US); Ron Kropp, West Palm Beach, FL (US); John Vandusen, Jupiter, FL (US); Trent Francis, Hobe Sound, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc.

(21) Appl. No.: 10/284,460

(22) Filed: Oct. 31, 2002

Related U.S. Application Data
(60) Provisional application No. 60/330,794, filed on Oct. 31, 2001.

(51) Int. Cl. G06F 17/60

(52) U.S. Cl. 705/1; 705/5

(57) ABSTRACT

A method and system use multi-tiered authorization for securing mass transit operations. The purchase rights of a consumer to travel on a medium of mass transit are verified. In some examples this verification can involve: transmitting identity (e.g., print data, facial data, universally unique identifier (UUID) data, or the like) and financial information (e.g., credit or debit card information, or the like) to a predetermined (e.g., third party vendor) party using a wireless transceiver biometric device, comparing the identity and financial data to previously stored data, and transmitting the results of the comparison to a consumer's present location. If verified, a transaction for purchase of travel rights is initiated. Information about the consumer and the travel is transmitted to a predetermined entity (e.g., a governmental entity, a third party vendor, or the like). Traveling rights of the consumer are verified before embarkation on the medium of mass transit.

### RELATED APPLICATIONS

This application claims priority under 35 U.S.C. § 119(e) to U.S. Prov. Appl. No. 60/330,794, filed Oct. 31, 2001, and is related to Appl. No. __/____, filed Oct. 30, 2002 (Attorney Docket No. 1823.0520007) which are incorporated herein by reference in their entireties.

### FIELD OF THE INVENTION

The present invention relates generally to a piezoelectric identification device and applications thereof. More particularly, it relates to a device for obtaining biometric information, such as a print, and using the obtained information to recognize and/or identify an individual.

### BACKGROUND OF THE INVENTION

Biometrics are a group of technologies that provide a high level. of security. Print capture and recognition is an important biometric technology. Law enforcement, banking, voting, and other industries increasingly rely upon prints as a biometric to recognize or verify identity. See, Biometrics Explained, v. 2.0, G. Roethenbaugh, International Computer Society Assn. Carlisle, Pa. 1998, pages 1-34 (incorporated herein by reference in its entirety). Generally, a biometric is a measurable, physical characteristic or personal behavior trait used to recognize the identity, or verify the claimed identity, of a person who has a biometric reference template (e.g., data that represents a biometric measurement) on file.

Optical print scanners are available which detect a reflected optical image of a print. To capture a quality image at a sufficiently high resolution, optical print scanners require at minimum optical components (e.g., lenses), an illumination source, and an imaging camera. Such components add to the overall cost of a print scanner. Mechanical structures to maintain alignment also increase manufacturing and maintenance costs.

Solid-state silicon-based transducers are also available in print scanners sold commercially. Such silicon transducers measure capacitance. This requires the brittle silicon transducers to be within a few microns of the print sensing circuit reducing their durability. To detect a rolled print, the sensing array of the solid-state transducer needs to have an area of 1 inch×1 inch and a thickness of about 50 microns. This is a big geometry for silicon that increases the base cost of a print scanner and leads to greater maintenance costs. Durability and structural integrity are also more likely to suffer in such a large silicon geometry.

In this era of terrorism and highjackings, it has become critical to know who is purchasing and boarding mass transit medium. Currently, there are not adequate systems to collect and monitor ticket purchasers and passengers. Typically, a customer uses a credit card to purchase rights to travel (e.g., tickets or vouchers) over the phone, through internet, or through a travel agent, and never needs to prove identity during the purchase. In some cases, the customer purchases the ticket with cash. Then, when the customer embarks, the only form of screening is to check an identification device against the name on the ticket. There is no way of knowing who the person really is, just that the names match.

What is needed is an inexpensive, durable print scanner with low maintenance costs. What is also needed is a system and method to screen customers both while they are purchasing a ticket or voucher and at the time of their embarkment onto a medium of mass transit.

### BRIEF SUMMARY OF THE INVENTION

Embodiments of the present invention provide a method including the steps of verifying purchasing rights of a consumer to travel on a medium of mass transit and after successfully completing the verifying step, transacting a purchase for the travel. The method further includes transmitting information about the consumer and the travel to a predetermined entity. The method further includes verifying traveling rights of the consumer before allowing embarkation on the medium of mass transit.

Embodiments of the present invention provide a system including a identity information capture device, a financial information capture device, a purchasing rights verification device coupled to the identity information capture device and the financial information capture device, and a traveling rights verification device coupled to the identity information capture device.

Systems and methods of the present invention can provide several advantages, such as: biometric level security, the are easily used with ubiquitous handheld wireless devices, they are relatively inexpensive to implement and operate, and they have high licensee integrity (e.g., only licensee can operate them).

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a wireless transceiver biometric device according to an embodiment of the invention.

FIG. 2 illustrates a more detailed view of the wireless transceiver biometric device of FIG. 1.

FIG. 3 illustrates a piezoelectric identification device according to an embodiment of the invention.

FIG. 4 illustrates circuit components of an identification device according to an embodiment of the invention.

FIG. 5 illustrates a wireless transceiver biometric device according to an embodiment of the invention.

FIG. 6 illustrates example environments in which the wireless transceiver biometric device of FIG. 1 can be used to complete different types of transactions.

FIG. 7 is a diagram illustrating an exemplary transaction between a consumer and a provider using a multi-tiered transaction according to an embodiment of the present invention.

FIG. 8 is a flowchart diagram of a routine for airline ticket purchase according to an embodiment of the present invention.

FIG. 9A is a diagram that illustrates a pre-flight upload of passenger manifest to a gate terminal according to an embodiment of the present invention.

FIG. 9B illustrates a pre-flight upload of passengers with security risks to security checkpoints according to an embodiment of the present invention.

FIG. 10 is a diagram of a routine embarkation of passengers according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

I. Overview of the Invention

Embodiments of the present invention provide a method and system using multi-tiered authorization for securing mass transit operations. The purchase rights of a consumer to travel on a medium of mass transit are verified. In some examples this verification can involve: transmitting identity (e.g., print data, facial data, universally unique identifier (UUID) data, or the like) and financial information (e.g., credit or debit card information, or the like) to a predetermined (e.g., third party vendor) party using a wireless transceiver biometric device, comparing the identity and financial data to previously stored data, and transmitting the results of the comparison to a consumer's present location. If verified, a transaction for purchase of travel rights is initiated. Information about the consumer and the travel is transmitted to a predetermined entity (e.g., a governmental entity, a third party vendor, or the like). Traveling rights of the consumer are verified before embarkation on the medium of mass transit.

The present invention relates generally to an identification device and applications thereof. More particularly, it relates to a device for obtaining biometric data or information, such as for a print, and using the obtained information to recognize and/or verify the identify of an individual. Print can be any type of print including, but not limited to, a print of all or part of one or more fingers, palms, toes, foot, hand, etc. A print can also be a rolled print, a flat print, or a slap print. The use of the term “data” or “information” throughout the specification can be representative of a biometric, a digital or other image of a biometric (e.g., a bitmap or other file), extracted digital or other information relating to the biometric, etc.

The use of the term “match” or “matching” can be defined as a one-to-one process of comparing a biometric sample against a previously stored template and scoring the level of similarity. Then, an accept or reject decision can be made based upon whether this score exceeds a predetermined threshold. Matching can be performed by comparing a party's print to one or more stored prints to either (1) determine if there is a match against the party's alleged identity or (2) a match against any stored print when there is no alleged identity.

The use of the term “verify” or “verification” can be defined as the process of comparing a submitted biometric sample against a biometric reference or template (e.g., data which represents a biometric measurement of an enrollee, used by a biometric system for comparison against subsequently submitted biometric samples) of a single enrollee whose identity is being claimed to determine whether the submitted biometric sample matches the enrollee's template.

The use of the term “identify” or “identification” can be defined as the one-to-many process of comparing a submitted biometric sample against all of the biometric reference templates on file to determine whether it matches any of the templates and, if so, the identity of the enrollee who template was matched.

II. Wireless Transceiver Biometric Devices

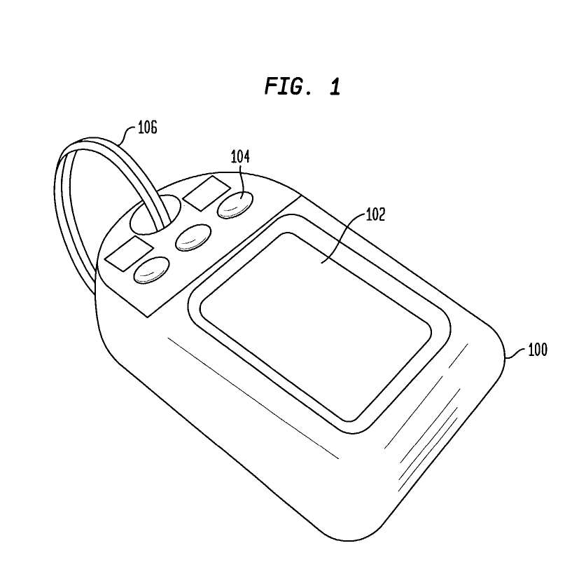

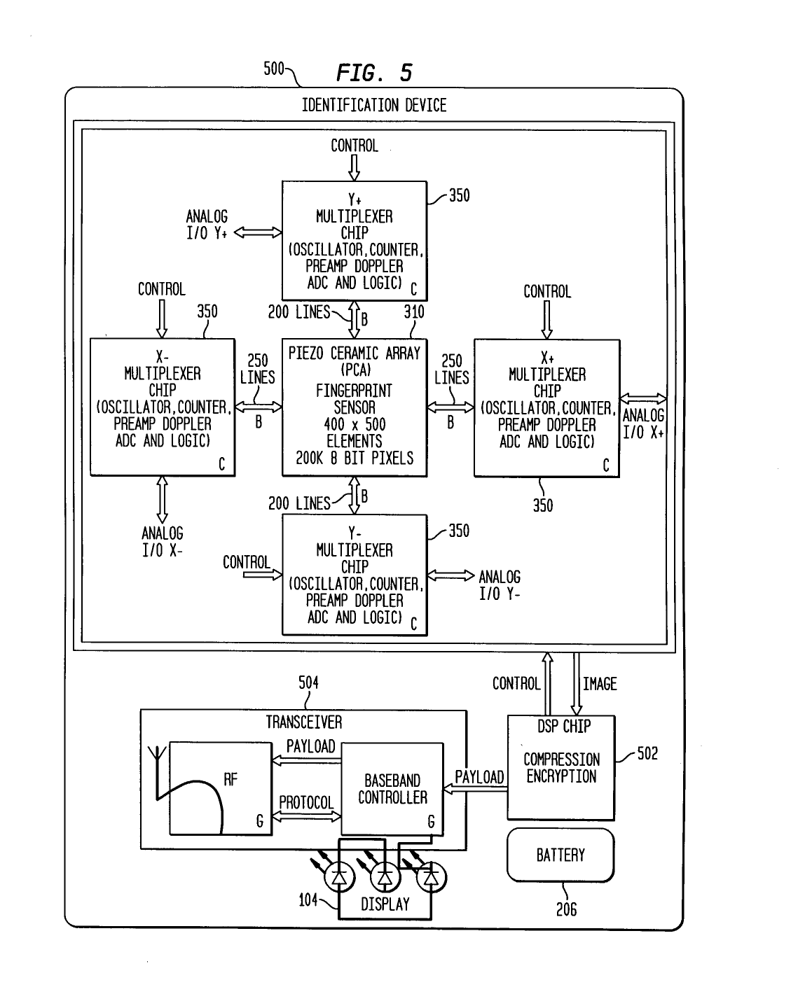

FIG. 1 illustrates a wireless transceiver biometric device 100 according to embodiments of the present invention. Device 100 is intended to be used by the general populace, for example, as an electronic signature device. Device 100 has a sensor 102 for obtaining biometric data (e.g., print data). In some embodiments, sensor 102 can be a piezo ceramic sensor or piezo electric thin film sensor. Device 100 can also have three indicator lights 104 for communicating information to a user. A key ring 106 can be attached to device 100. In same embodiments wireless transceiver biometric device 100 includes a BLUETOOTH wireless transceiver biometric device, as described further below with respect to FIG. 5.

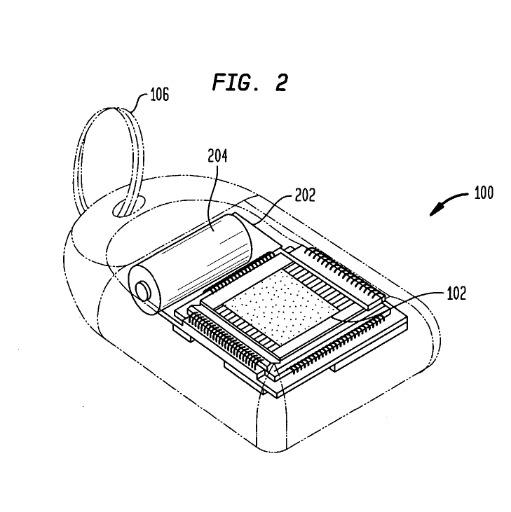

FIG. 2 illustrates a more detailed view of wireless transceiver biometric device 100 according to embodiments of the present invention. Device 100 has an antenna 202 that can be used for sending information to and receiving information from other devices. Sensor 102 is powered by a battery 204. In some embodiments, device 100 can be made to be compatible with BLUETOOTH wireless technology, as discussed above. Various uses of device 100 are described below in reference to FIGS. 6-10.

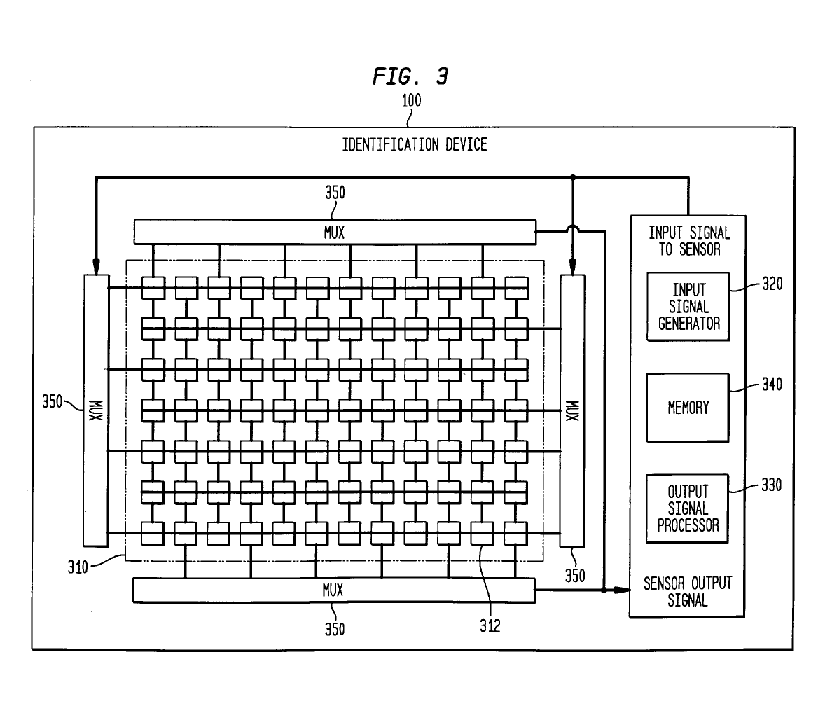

FIG. 3 is a schematic diagram of wireless transceiver biometric device 100 according to embodiments of the present invention. Identification device 100 has a piezoelectric sensor 310, a sensor input signal generator 320, a sensor output signal processor 330, and a memory 340. The input signal generated by input signal generator 320 is coupled to sensor 310 by two multiplexers 350. The output signal of sensor 310 is similarly coupled to output signal processor 330 by two multiplexers 350. In some embodiments, sensor 310 can be an array of piezo ceramic elements. In some embodiments, sensor 310 can include an array of polycrystalline ceramic elements that are chemically inert and immune to moisture and other atmospheric conditions. Polycrystalline ceramics can be manufactured to have specific desired physical, chemical, and/or piezoelectric characteristics. In other embodiments, sensor 310 can include a piezoelectric film (e.g., a polarized fluoropolymer film, such as polyvinylidene fluoride (PVDF) film or its copolymers can be used).

More detailed information on the elements and functions of the wireless transceiver biometric device can be found in the 60/330,794 Prov. App, which is incorporated by reference herein in its entirety.

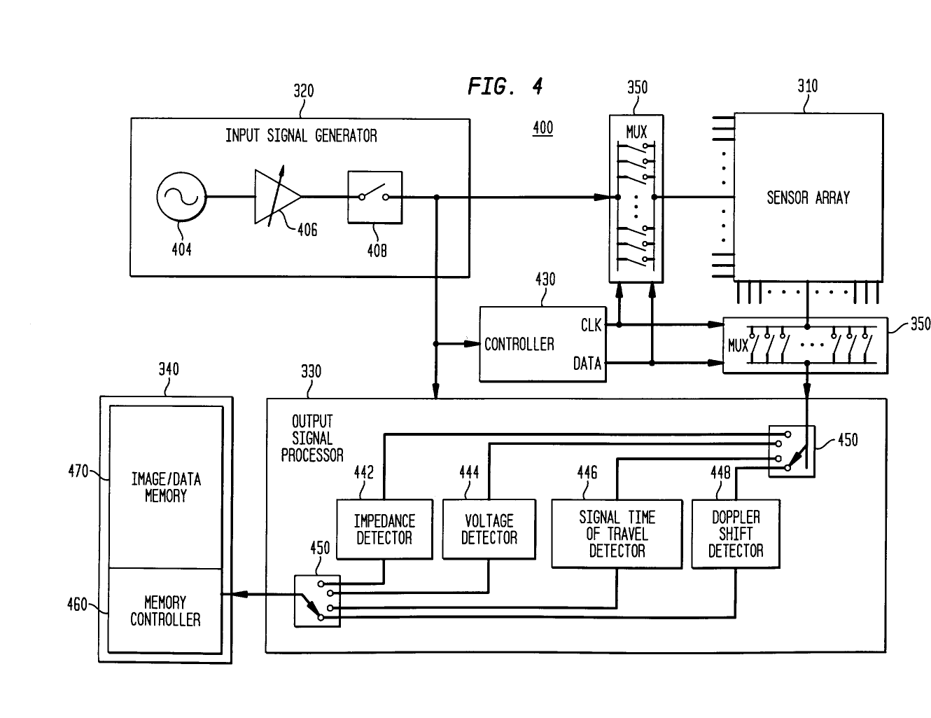

FIG. 4 illustrates an identification device 400 according to embodiments of the present invention. Device 400 includes an input signal generator 320, a sensor array 310, an output signal processor 330, a memory controller 460, and a memory 470. Sensor array 310 is coupled to input signal generator 320 and output signal processor 330 by multiplexers 350. A controller 430 controls the operation of multiplexers 350. The operation of identification device 400 is further described below.

In some embodiments, input signal generator 320 includes an input signal generator or oscillator 404, an variable amplifier 406, and a switch 408. In an embodiment, oscillator 404 produces a 20 MHz signal, which is amplified to either a low or a high voltage (e.g., about 4 volts or 8 volts) by variable amplifier 406, depending on the mode in which device 400 is operating. Switch 408 is used to provide either no input signal, a pulsed input signal, or a continuous wave input signal. Switch 408 is controlled to produce the various types of input signals described herein in a manner that would be known to a person skilled in the relevant art. The input signal generated by input signal generator 320 is provided to sensor array 310 via multiplexer 350, to controller 430, and to output signal processor 330. In an embodiment, sensor array 310 is a piezo ceramic composite of rectangular elements designed to operate with a 20 MHz input signal.

The output signal processor 330 includes various biometric detection devices, including an impedance detector 442, a voltage detector 444, a signal time of travel detector 446, and a doppler shift detector 448. Only one detector 442, 444, 446, or 448 is usually functioning during a period of time. Thus, switches 450 are used to coupled the functioning detector 442, 444, 446, or 448 to memory 340 and multiplexer 350. Further description of the operation of these detectors is found in U.S. Prov. App. 60/330,794, which is incorporated by reference herein in its entirety.

III. Example Applications

A. Overview of Applications

In some embodiments, one wireless transceiver biometric device 100 or 400 (e.g., BLUETOOTH device 500 with a piezo ceramic sensor as discussed below) can wirelessly communicate to different types of devices (e.g., computer mice, physical access control units, telephones, palm devices, set top boxes, computers, ATM machines, keyboards, locks, ignitions, etc.) to provide additional biometric-based security so that only an authorized person can operate the respective devices or gain a desired access or authorization. For example, wireless transceiver biometric device 100 or 400 (e.g., BLUETOOTH device 500 with a piezo ceramic sensor) can communicate over a piconet to a telephone to provide additional security so that only an authorized person can be operate the telephone. Similarly, wireless transceiver biometric device 100 or 400 can communicate to a remote control device to enhance security relating to the authorized use of set top boxes, televisions, recorders, players or other devices.

In other embodiments, a wireless transceiver biometric device 100 or 400 (e.g., BLUETOOTH device 500 with a piezo ceramic sensor) can be incorporated into any type of device where additional biometric security is desired. For example, wireless transceiver biometric device 100 or 400 can be incorporated in a telephone (not shown) to provide additional security so that only an authorized person can be operate the telephone. Similarly, wireless transceiver biometric device 100 or 400 can be built in a remote control device (not shown) to enhance security relating to the authorized use of set top boxes, televisions, recorders, players, or other devices.

In still other embodiments, device 100 or 400 can be used for: building access control; law enforcement; electronic commerce; financial transaction security; tracking employee time and attendance; controlling access to legal, personnel, and/or medical records; transportation security; e-mail signatures; controlling use of credit cards and ATM cards; file security; computer network security; alarm control; and identification, recognition, and verification of individuals.

In still other embodiments, wireless transceiver biometric device 100 or 400 is a low-cost, ubiquitous device that identifies a person and records the signature through both the print image and biological features such as blood flow. Information is transmitted to the other person(s) engaged in a transaction via a BLUETOOTH wireless network with other devices in the BLUETOOTH networks, such as a controller, a processor or computer (e.g., palm device, PDA, laptop, desktop, server, etc.), a set top box, a cellular telephone, a land-line telephone, and/or a vehicle (e.g., an automobile). Wireless transceiver biometric device 100 or 400 transmits authorization functions for physical access and alarm control, ignition control, computer and network access control, e-mail signatures, credit card transactions, cell phone identification, airline transactions, financial enrollment transactions, etc. via BLUETOOTH piconets.

In still other embodiments, wireless transceiver biometric device 100 or 400 can include a piezo ceramic sensor used for applications within many market segments including, but not limited to, financial, physical access control, automotive, telecommunications, computers, law and order, health care, immigration, and welfare markets. For example, in one financial market segment application, wireless transceiver biometric device 100 or 400 is used for physical access control for bank employees, cardholder verification and secure transaction certification. As another example, in one physical access control market segment application, wireless transceiver biometric device 100 or 400 can be used for automotive access and theft control, garage door, house access and activation of domestic security systems. As a still further example, in one automotive market segment application, wireless transceiver biometric device 100 or 400 can be used as an access and ignition control device. As a still further example, in one computer market segment application, wireless transceiver biometric device 100 or 400 can interact in a biometric device for network access control.

In still other embodiments, in one telecommunications market segment application, wireless transceiver biometric device 100 or 400 can be incorporated in a telephone. A wireless telephone or land-line telephone incorporates at least a sensor array, such as, a piezo ceramic sensor array or piezo electric thin film sensor array according to embodiments of the present invention. Communication and digital signal processor (DSP) functions can be carried out by the other components in the telephone. In other embodiments, BLUETOOTH is incorporated into both cellular and fixed station telephones for proximal communications. The telephone is then a flexible portal that the consumer will use to assert biometric authorizations and/or identifications according embodiments of the present invention.

These are just a few of the many useful applications of device 100 or 400 in particular, and the present invention in general. Additional applications for device 100 or 400 and the invention will be apparent to those skilled in the relevant arts given the description of the invention herein.

B. Personal Area Network Applications

FIG. 5 illustrates a wireless transceiver biometric device 500 according to embodiments of the present invention. As described herein, embodiments of the invention are capable of interacting with other devices as part of a personal area network. Device 500 includes a biometric device (labeled as an identification device), which is similar to device 400, and which includes a DSP chip 502, a BLUETOOTH chip 504, a display (which can be similar to 104), and a battery 206. The identification device can have a piezo ceramic sensor array 310 and four multiplexers 350, according to embodiments of the invention. The identification device is coupled to DSP 502. DSP 502 controls the identification device and stores biometric data. DSP 502 is also coupled to BLUETOOTH chip 504 for sending and receiving data. The display is used to communicate information to a user of device 500. Device 500 is powered by battery 206.

As would be known to a person skilled in the relevant art, BLUETOOTH is an agreement that governs the protocols and hardware for a short-range wireless communications technology. The invention is not limited to implementing only the BLUETOOTH technology. Other wireless protocols and hardware can also be used.

With continuing reference to FIG. 5, device 500 allows an individual to be in communication with compatible devices within about 30 feet of device 500. Device 500 can connect, for example, with telephones, cell phones, personal computers, printers, gas pumps, cash registers, Automated teller machines, door locks, automobiles, set top boxes, etc (none shown). Device 500 is able to supply a standardized secure identification or authorization token to any device, or for any process or transaction that needs or requests it. This is because device 500 can connect to and exchange information or data with any compatible device within a personal area network or piconet.

C. Electronic Sales and/or Transaction Applications

FIG. 6 illustrates using the wireless transceiver biometric device (e.g., device 100, 400, and/or 500) to provide security and/or to complete various transactions, according to embodiments of the present invention. The transactions shown, which are not exhaustive, include: alarm control, access and ignition control of a vehicle, network security, file security, e-mail signatures, credit and ATM cards, a cash register, long distance and www purchases, cellular, boarding pass and seat assignments, luggage collection, medical records, legal records, finical records, time and attendance records, access control, or the like.

D. Multi-Tiered Authorization and Identification Applications

In an embodiment of the invention, multi-tiered transactions may occur. Multi-tiered transactions may provide additional services, such as, for example, insurance on the transaction. Multi-tiered transactions may also provide an additional levels of security. Although this is described using an insurance service as the additional tier, the invention is not limited to insurance services. Other types of services could be used without departing from the scope of the invention.

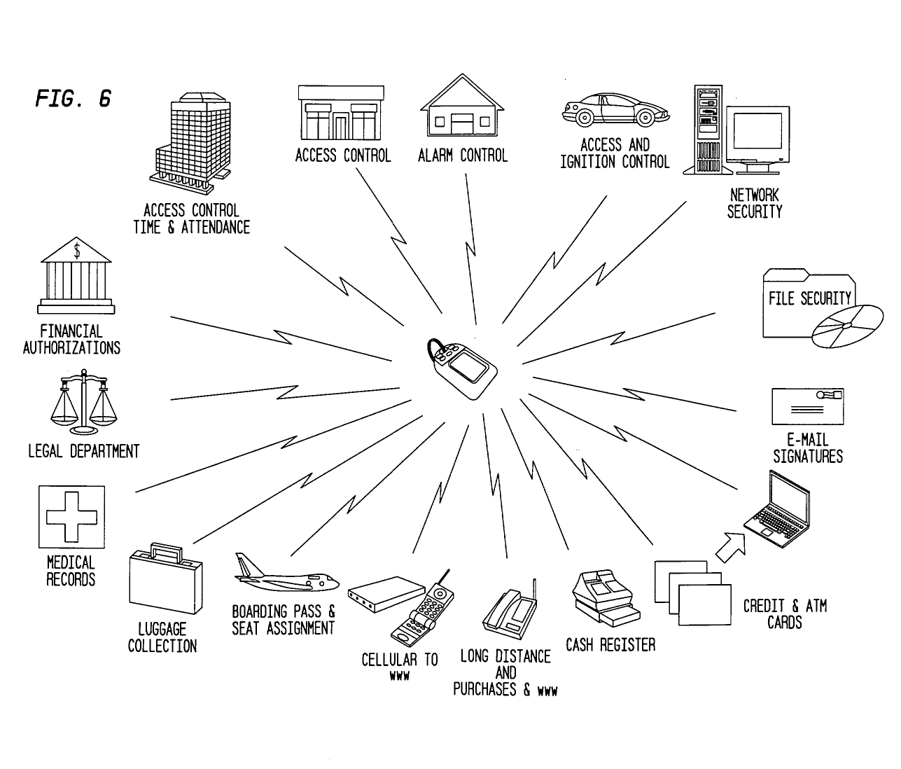

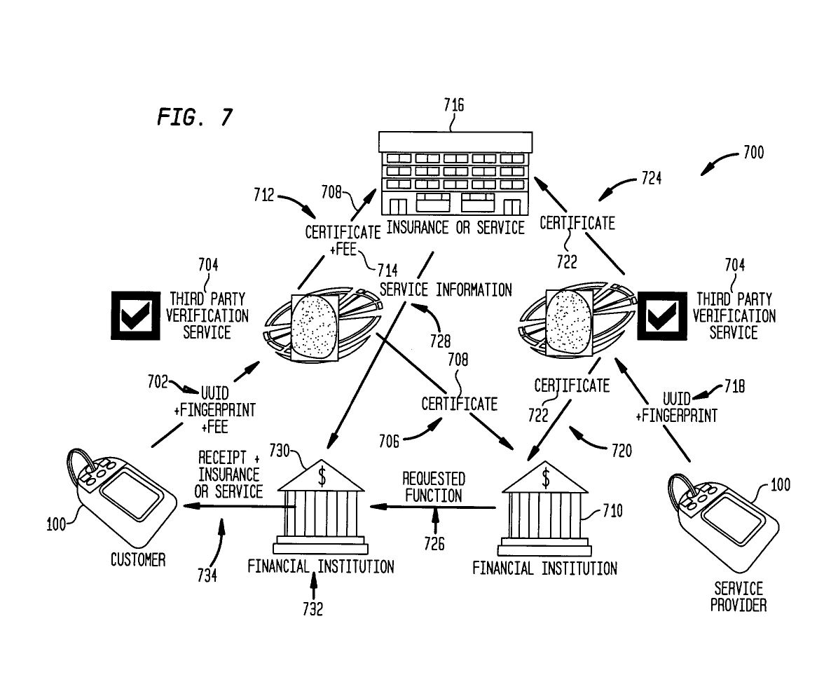

FIG. 7 is a diagram illustrating an multi-tiered transaction operation 700 between a consumer and a provider according to an embodiment of the present invention. In step 702, the customer submits a universally unique identifier (UUID) (e.g., a unique 128 bit long identifier that is unique across a combination of time and space fields), a print, and a fee into his/her wireless transceiver biometric device 100. This information is transmitted to third party verification service 704. The fee would be a money transfer that is uploaded for purchase of the service. Third party verification service 704 receives the print, UUID, and fee and uses the received print to verify the identity of the customer by matching the received print to print data stored in a database. In step 706, information related to the customer's identity and the customer's legitimacy to perform the transaction is transmitted from third party verification service 704 in the form of a certificate of authentication 708 to a financial institution 710. In step 712, third party verification service 704 sends certificate 708 and a fee 714, to an insurance service or some other service provider 716 that monitors the transaction.

In step 718, the service provider submits a UUID and print to third party verification service 704 using the service provider's wireless transceiver biometric device 100. Third party verification service 704 receives the print and UUID and uses the received print to verify the identity of the service provider by matching the received print to print data stored in a database. In step 720, information related to the service provider's identity and legitimacy to perform the transaction is transmitted from the third party verification service 704 in the form of a certificate of authentication 722 to financial institution 710. In step 724, the certificate 722 is sent by third party verification service 704 to service 716 that monitors the transaction.

In step 726, if both parties meet the required qualifications, the transaction is in a position to move forward. In step 728, service 716, after reviewing the qualifications of both parties, transmits to financial institution insurance 730, which in some embodiments can be financial institution 710, service information or other information indicating whether to proceed with the transaction, even if both parties are qualified. In step 732, if all responses indicate that the transaction should move forward, the transaction will transpire. In step 734, documentation of the transaction and the insurance service is provided to the customer.

In various other embodiments the multi-tiered transaction operation provides additional levels of security. Thus, insurance service 716 can be a government agency that reviews suspicious activity according to embodiments of the invention. An embodiment an embodiment of the present invention uses a virtual wallet to allow the government to track foreign nationals with suspicious and/or known volatile backgrounds and to prevent any individual and/or group of individuals from amassing arsenals without the government's knowledge. This invention would require not only U.S. citizens to register his/her print and UUID with a centralized law enforcement agency, but would also require all foreign nationals to register his/her prints and UUIDs upon entry into the country. The wireless transceiver biometric device 100 of the present invention can be used to replace printed documents, such as a driver's license, identification card, credit cards, pilot's licenses, passports, etc. In some embodiments, a cashless system can be employed. Through the wireless transceiver biometric device 100, money transfers, credit lines, etc., can be uploaded for purchases. Foreign nationals would be required to purchase a wireless transceiver biometric device 100 to upload money transfer, credit lines, etc, from the foreign national's place of origin. In some embodiments, authorizer verification and identification, as described above, is also forwarded to government agencies when large monetary transactions occur, when purchases of restricted products (e.g., firearms, explosives, and other weaponry) occur and when travel that is deemed non-rapid (e.g., air travel, cruise ship travel, trains, etc.) occur.

In some embodiments, authorizer verification and identification of weaponry would provide a “cooling off” period for all purchases of weapons during which time a governing agency could review the request for purchase and investigate the purchaser. Also, this can prevent “under the table” transactions for weapons, flight training, etc., by eliminating cash transfer for transactions deemed “restricted” and allow visibility of these types of transactions to the government. Further, this can reduce or eliminate “black market” transactions such as arms and drugs within the borders of the country.

1. Mass Transit Security Applications

In embodiments using multi-tiered authorization and identification application operations, non-rapid mass transit organizations (e.g., air, cruises, trains, etc.) can both positively identify a customer during original purchase transaction and positively identify the customer during embarkation by providing uploaded information about the passenger to the gate terminal based on a manifest. This can include photographs, print minutia, passport information, etc., and could alert law enforcement for possible intervention when a customer with links to subversive groups is planning to travel.

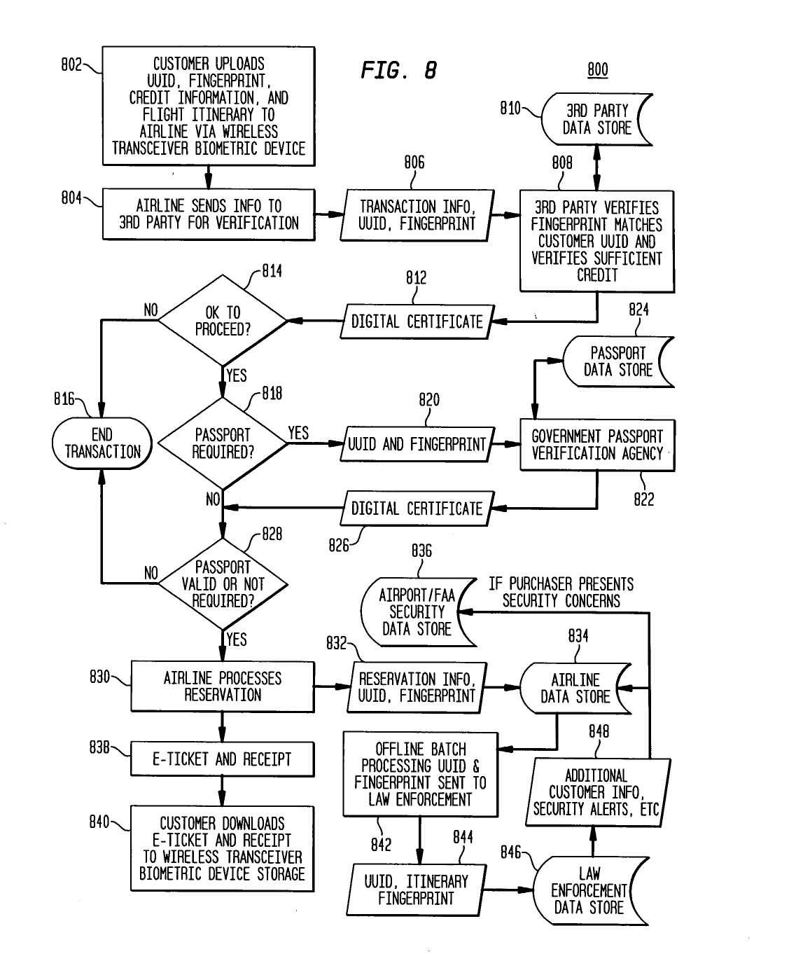

FIGS. 8, 9A, 9B, and 10 are flow diagrams illustrating an example of airline travel from ticket purchase to passenger embarkation according to an embodiment of the present invention. It is to be appreciated, all other mediums of transportation can function similarly, and are contemplated within the invention.

FIG. 8 is a flowchart of a method 800 for airline ticket purchase according to an embodiment of the present invention. In step 802, a customer uploads a UUID, print, credit information, and flight itinerary to an airline company or airline system (hereinafter “airline”) via wireless transceiver biometric device 100. In step 804, the airline then sends information 806 to a third party for verification. Information 806 can include transaction information, UUID, and/or print information. This information can be sent over any type of network including, but not limited, to an Intranet or the Internet. In step 808, the third party service verifies that the print information matches a customer's pre-stored information based on the UUID. The third party service then verifies that the customer has sufficient credit. The operation of step 808 can be performed using information pre-stored in third party data store 810. If a customer is determined to have sufficient credit and the print matches the customer UUID, then in step 812 the third party service issues a digital certificate indicating approval. This digital certificate is sent back to the requesting airline. In step 814, the airline determines whether or not its okay to proceed. If an approved digital certificate has not been received or it is not okay to proceed, then method 800 proceeds to step 816 and the transaction is ended. Otherwise, if an approved digital certificate is received and it is okay to proceed, then method 800 proceeds to step 818. In step 818, the airline determines whether a passport is required. If a passport is required (e.g., because of an international flight), at step 820 UUID and print information is sent to a government passport verification agency. In step 822, the government passport verification agency verifies whether a valid passport exist for the customer associated with the UUID and print information. The government passport verification agency can make this determination based on passport data stored in a database 824. If a valid passport exists, at step 826 the government passport verification agency issues a digital certificate. This digital certificate is then returned to the requesting airline.

In step 828, the airline determines whether the passport is valid or not required. If the airline determines that a valid passport is present based on receipt of the digital certificate, method 800 proceeds to step 830. Also if a passport is not required, such as in the case of a domestic flight, then method 800 proceeds to step 830. If a valid passport is required and a valid digital certificate has not been received, then method 800 proceeds to step 816 and the transaction is ended.

In step 830, the airline continues to process the reservation. In step 832, reservation information, UUID, facial information (e.g., photographs, digital images, facial scan information, and the like), and print information is sent from the airline to an airline data store (e.g., a database) 834. Separate offline or asynchronous operations are performed against data stored in airline data store 834. For example, these operations can relate to law enforcement monitoring of potential passengers. Also in step 830, the airline continues to process a reservation by generating an E-ticket and receipt 838. In step 840, a customer can download the generated E-ticket and receipt and store it in wireless transceiver biometric device 100.

Law enforcement operations performed on data stored in airline data store 834 to improve airline security are now described. In step 842, an offline batch processing routine is initiated. This offline batch processing includes sending UUID and print information stored in airline data store 834 to a law enforcement entity, such as local, state, and/or federal authorities. In step 844, UUID, itinerary of a passenger, and print information can be sent over a network to law enforcement data store 846. The law enforcement authorities can then evaluate and analyze the received customer UUID, itinerary, and print information. For example, in step 848 law enforcement can generate a security alert, send additional customer information, or generate other commands and send this information to the airline data store, an airport data store, and/or an FAA security data store 836. Law enforcement can also indicate whether a particular ticket purchaser presents a security concern based on law enforcement criteria or other known information.

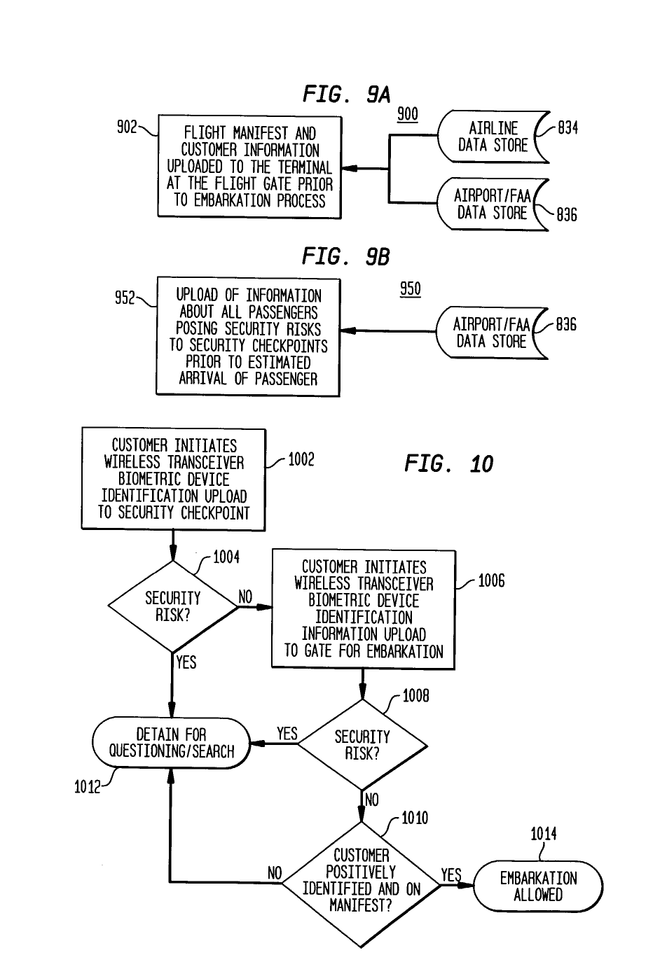

FIG. 9A is a diagram that illustrates a method 900 for pre-flight uploading of a passenger manifest to a gate terminal according to embodiments of the present invention. Airline data information is stored in the airline data store 834. Airport and or FAA data is stored in the airport/FAA data store 836. In step 902, flight manifest and customer information is uploaded to the terminal at a flight gate prior to embarking.

FIG. 9B illustrates a method 950 for pre-flight uploading of information about passengers with security risks to security checkpoints according to embodiments of the present invention. Information on passengers that pose a potential security risk is stored in airport/FAA data store 836. This information is uploaded in step 952 to security checkpoints. In this way, an upload of all passengers posing security risks is made to security checkpoints prior to an estimated arrival of a passenger.

FIG. 10 is a flowchart of a method 1000 for routine embarkation of passengers according to embodiments of the invention. In step 1002, a passenger or customer initiates wireless transceiver biometric device 100 to send or upload identification information to a security checkpoint. For example, the identification can include a customer UUID and print information. In step 1004, a determination is made whether the customer presents a security risk. This can be based on previously uploaded information at the security checkpoint. If the customer does present a security risk, in step 1012 the customer is detained for questioning and/or further search, and is not allowed to proceed through security. Also, the customers baggage or other personal belongings can be removed from transit, searched, and/or confiscated. If the customer does not present a security risk, then method 1000 proceeds to step 1006.

In step 1006, a customer initiates uploading of identification information using the wireless transceiver biometric device 100 at a gate terminal. Wireless transceiver biometric device 100 can send UUID and print information to a gate terminal prior to embarkation. The gate terminal can then compare the UUID and print information sent from wireless transceiver biometric device 100 with data previously uploaded, as described above with respect of FIG. 9A. In step 1008, a determination is made whether or not the customer presents a security risk. If the customer does present a security risk, then method 1000 proceeds to step 1012. Otherwise, method 1000 proceeds to step 1010. In step 1010, a gate agent determines whether or not a customer is positively identified and is listed on a manifest. Positive identification can include a positive identification or match of the print the customer sends through wireless transceiver biometric device 100 to the gate terminal and a proper listing of the customer name on the manifest. In step 1014, embarkation is allowed onto the plane or other vehicle for customers having a positive ID and if his/her name appears on the manifest.

Compatibility Feature

As described above, embodiments of the invention are capable of interacting with other devices as part of a personal area network. The personal identification device of the invention can be implemented to communicate with other devices using any known wireless communications system or protocol, such as BLUETOOTH and/or IEEE 802.11.

Conclusion

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method comprising the steps of:
verifying purchasing rights of a consumer to travel on a medium of mass transit;
after successfully completing said verifying step, transacting a purchase for said travel;
transmitting information about the consumer and said travel to a predetermined entity; and
verifying traveling rights of the consumer before allowing embarkation on the medium of mass transit.

2. The method of claim 1, wherein said verifying purchasing rights step comprises:
transmitting identity data to a verification service using a wireless transceiver biometric device;
transmitting financial data to a verification service using the wireless transceiver biometric device;
comparing the identity data and the financial data to stored data; and
transmitting a result of said comparing step.

3. The method of claim 2, wherein said transmitting identity data step includes capturing at least one of print data, facial data, and universally unique identifier (UUID) data from the consumer and transmitting said captured data.

4. The method of claim 2, wherein said transmitting financial data step includes receiving credit card data from the consumer and transmitting said received data.

5. The method of claim 2, wherein said transmitting financial data step includes receiving bank data from the consumer and transmitting said received data.

6. The method of claim 1, further comprising the step of determining if additional information is needed to verify purchasing rights.

7. The method of claim 6, wherein said determining step comprises determining if a passport is required for said travel.

8. The method of claim 1, wherein said transmitting information step comprises:
sending at least one of print data, facial data, and UUID, some of which are captured with a wireless transceiver biometric device; and
itinerary information.

9. The method of claim 1, wherein said transmitting information step comprises choosing a governmental agency as the predetermined entity.

10. The method of claim 9, wherein said choosing step includes choosing a policing authority as the governmental authority.

11. The method of claim 1, wherein said verifying traveling rights step comprises:
transmitting identity data to a verification service using a wireless transceiver biometric device;
comparing the identity data to stored data; and
transmitting a result of said comparing step.

12. The method of claim 11, wherein said transmitting step occurs while the consumer is at a security check point.

13. The method of claim 11, wherein said transmitted step occurs while the consumer is at an embarkation point.

14. The method of claim 11, wherein said verifying traveling rights step further comprises using the result to determine if the consumer is a security risk.

15. The method of claim 1, further comprising the step of having the predetermined entity perform a predetermined action based on said transmitting information step.

16. The method of claim 15, wherein said predetermined action is tracking the consumer.

17. The method of claim 15, wherein said predetermined action is detaining the consumer.

18. The method of claim 15, wherein said predetermined action is at least one of removing, searching, and confiscating items associate with the customer from transit to the medium of mass transit.

19. The method of claim 15, wherein said predetermined action is altering other predetermined entities.

20. A system comprising:
a identity information capture device;
a financial information capture device;
a purchasing rights verification device coupled to said identity information capture device and said financial information capture device; and
a traveling rights verification device coupled to the identity information capture device.
